(19) United States
(12) Patent Application Publication
(10) Pub. No.: US 2007/0263650 A1
(43) Pub. Date: Nov. 15, 2007

(54) Method for prioritizing web service requests

(76) Inventors: Srivatsa Sivan Subramania, Bangalore Karnataka (IN); Venkatavaradan Ragunathan, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/531,695

(22) Filed: Sep. 14, 2006

(30) Foreign Application Priority Data
May 9, 2006 (IN) 780/CHE/2006

(51) Int. Cl. H04L 12/56

(52) U.S. Cl. 370/412; 370/468

(57) ABSTRACT

A method for prioritizing web service requests in a web service container is provided. The method includes receiving a web service request, identifying a web service requested by the web service request, determining any parameter of the web service request, determining a priority for the web service request and adding the web service request to a queue. The queue includes one or more web service requests, and the positions of the web service requests in the queue are arranged based on their respective priority. The web service requests in the queue are processed sequentially, thereby achieving prioritization of web service requests.

### FIELD OF THE INVENTION

The invention relates generally to web services, and in particular, to a method for prioritizing web service requests in a web service container.

### BACKGROUND OF THE INVENTION

Many people access the Internet to obtain and provide information through a web browser. A user requests information by sending a web page request. The web page request is sent to a web server which then returns the requested web page containing the information described in HyperText Markup Language (HTML). The HTML defines the attributes and layout of the web page. The web page is displayed on the web browser for the user. Accordingly, web browsers generally provide information to humans.

Web services, on the other hand, provide information to applications in a Service-Oriented Architecture (SOA) environment. The user requests services from a web service by sending a web service request to a web service container. The web service request is normally described in eXtensible Markup Language (XML) or any other XML-based language. The web service request is parsed and processed by the web service container. Responses from the requested web service are returned to the user, which is subsequently parsed and processed by suitable applications at the user end.

The web service container provides a platform for deploying and running web services. Specifically, the web service container receives the web service request from the user, parses the request and calls the requested web service to process the request. After the request has been processed by the requested web service, the web service container retrieves the response or information from the requested web service and returns the information to the user.

Due to the high level of interoperability, many enterprises have adopted the use of web services. The rapid adoption and implementation of web services may also be due to the use of standard protocols. With such rapid adoption of web services, the number of web service requests increases tremendously.

However, the current web service containers are “web service priority agnostic”, that is, the web service containers have no way of determining which of the web service requests they received have a higher priority than the rest of the requests. For example, an emergency 911 web service request and a non-emergency movie-ticketing web service request are treated equally by the web service containers. A current solution is to have a powerful, dedicated, but limited network capacity server for processing only high priority web services. However, when new high priority web services are to be added to this dedicated server, the manageability of the high priority web services becomes complicated. Moreover, cost will also increase exponentially.

It is desirable to provide a method for prioritizing web services in a web service container.

### SUMMARY OF THE INVENTION

In an embodiment, a method for prioritizing web service requests in a web service container is provided. The method includes receiving a web service request, identifying a web service requested by the web service request, determining any parameter of the web service request, determining a priority for the web service request and adding the web service request to a queue. The queue includes one or more web service requests, and the positions of the web service requests in the queue are arranged based on their respective priority. The web service requests in the queue are processed sequentially, thereby achieving prioritization of web service requests.

### BRIEF DESCRIPTION OF THE DRAWINGS

The embodiments of the invention will be better understood in view of the following drawings and the detailed description.

FIG. 1 shows an architecture of a web service container according to an embodiment.

FIG. 2 shows a flow chart of a process for prioritizing web service requests according to an embodiment.

FIG. 3 shows a flow chart of a process for processing web service requests in a priority queue according to an embodiment.

### DETAILED DESCRIPTION OF THE INVENTION

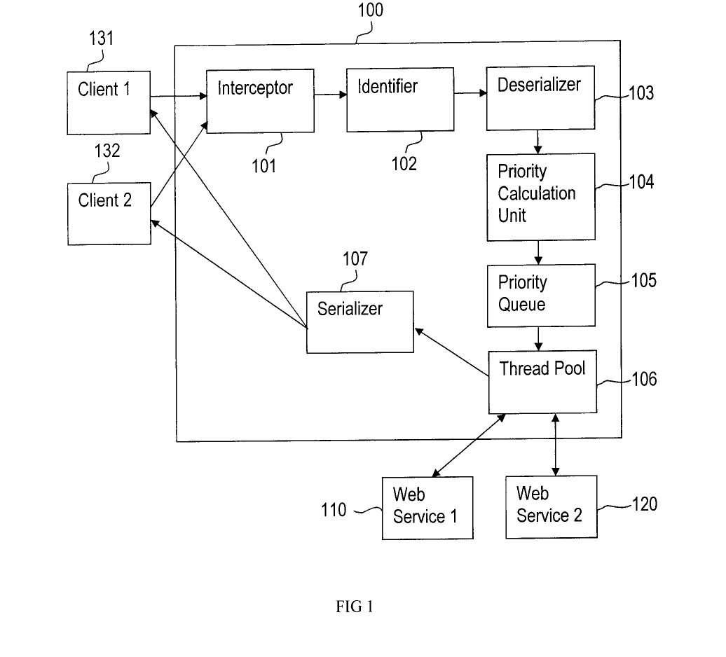

FIG. 1 shows an exemplary architecture of a web service container 100 according to an embodiment. The web service container 100 includes an interceptor 101, an identifier 102, a deserializer 103, a priority calculation unit 104, a priority queue 105, a thread pool 106 and a serializer 107. The thread pool 106 interfaces with a first web service 110 and a second web service 120.

The web service container 100 receives web service requests from requesting applications resided in client systems 131, 132. Each web service request includes web service messages which are normally specified using the eXtensible Markup Language (XML). An XML-based protocol may also be used to specify envelop information, contents and processing information for the messages to form the web service request. An example of such an XML-based protocol is the Simple Object Access Protocol (SOAP). The SOAP web service messages, that is, the web service requests, are normally transported between the client systems and web service containers over the Internet using the HyperText Transfer Protocol (HTTP) or HTTP over Secure Socket Layer (HTTPS).

The web service requests are received by the interceptor 101 of the web service container 100. The interceptor 101 is a component that constantly listens for incoming requests that come to the web service container 100. The interceptor 101 also decodes the web service requests by parsing and determining the content of the web service requests accordingly.

The identifier 102 identifies a web service which is requested by a web service request. The identifier 102 may identify the requested web service from the decoded web service request or from the URL in the web service request itself. The deserializer 103 deserializes the web service request, which converts request parameters of the web service request represented in the XML structure into a representation or structure which the web service container 100 operates in. In an embodiment, the request parameters of the web service request are converted from a SOAP structure into Java objects.

The priority calculation unit 104 calculates the priority of the web service request. The priority is calculated or defined based on business logics. For example, a web service request for 911 web service will be given a high priority or assigned a high priority value. Similarly, a web service request for movie-ticketing web service may be given a low priority or assigned a low priority value. It is also possible to set the priority of the web service request based on parameters of the HTTP headers appended to the web service request. For example, the HTTP headers may include a parameter CUSTOMER_TYPE. If the parameter CUSTOMER_TYPE is set to “GOLD CUSTOMER”, the priority of the corresponding web service request may be assigned a high value. It should be noted that it is also possible for any business logics for calculating the priority of the web service request to be plugged into the web service container 100 as the priority calculation unit 104. Accordingly, the architecture of the web service container 100 for calculating the priority is loosely coupled from the business logic and is extensible.

Based on the priority value, the web service request is added to the priority queue 105. The priority queue 105 may already include other web service requests queuing to be processed. The web service requests in the priority queue 105 are arranged in accordance with their respective priority values. Specifically, the web service request with the highest priority value is arranged at the front of the priority queue, and the web service request with the lowest priority is arranged at the end. Depending on the priority value of the web service request, the web service request is added to a corresponding position in the priority queue 105.

In an embodiment, the web service request is added to the priority queue 105 as a thread object. The thread object implements the Comparable Interface of Java, and includes a priority data member. The priority queue 105 also includes other thread objects corresponding to other web service requests arranged in accordance with their priority values. Each of these other thread objects in the priority queue also includes a priority data member and implements the Comparable Interface of Java. The priority data member corresponds to the priority value of the respective web service request.

When the thread object is added to the priority queue 105, the value of the priority data member of the newly added thread object is compared with the value of the priority data members of the other thread objects, and the position of the newly added thread object in the priority queue 105 is determined accordingly. In another embodiment, the thread object is added to the last position of the priority queue 105. The value of the priority data member of this newly added thread object at the last position of the priority queue 105 is compared with the value of the priority data member of the thread object at the second last position of the priority queue. If the value of the priority data member of the last thread object is higher than that of the second last thread object, the positions of these two thread objects are switched.

Accordingly, the newly added thread object is now at the second last position in the priority queue 105. The value of the priority data member of the newly added thread object at the second last position is compared with that of the next thread object, that is, the third last thread object. If the value of the priority data member of the newly added thread object is higher than that of the third last thread object, the positions of these two thread objects are switched again. This process of comparing the values of the priority data members of the newly added thread object and the next thread object, and switching of positions continue until the value of the priority data member of the next thread object is higher than that of the newly added thread object. Accordingly, the newly added thread object is placed in the priority queue 105 based on its priority value.

There may be a situation where newly added web service requests are always assigned higher priority than the low priority web service requests at the end of the priority queue 105. In such a situation, the web service requests at the end of the priority queue 105 may never be able to be processed because of their low priority values. These web service requests are “starved”, a situation known as “thread starvation”. Accordingly, the priority calculation unit 104 may include business logics or rules to prevent thread starvation. For example, the priority values of all the web service requests in the priority queue 105 may be increased after a predefined time. In this way, low priority web service requests at the end of the priority queue 105 need not remain low priority forever, and can move up the queue 105.

In a thread pool, a predefined number of threads are usually created for executing a certain number of tasks. The threads usually obtain the tasks from a queue. When all the threads are used, a next task in the queue has to wait until one of the threads has finished executing its current task and is available to execute the next task. The advantage of using a thread pool is that the overheads for creating and destroying one thread for each task is eliminated.

In this embodiment, the thread pool 106 assigns an available thread for executing a web service request from the priority queue 105. The assigned thread retrieves the web service request from the front of the priority queue 105, that is, the web service request at the first position in the priority queue. In other words, the web service request having the highest priority is always retrieved and executed. The corresponding web service 110, 120 requested by the retrieved web service request is invoked, together with the request parameters associated with the retrieved web service request, if any. When the invoked web service returns a response corresponding to the web service request, the thread retrieves the response for the serializer 107 for serialization.

It is also possible to create a new thread for executing each web service request from the priority queue 105 according to another embodiment. Accordingly, a thread factory may be used for creating new threads and destroying them upon completion of the execution of the corresponding web service requests.

The serializer 107 serializes the response retrieved from the web service 110, 120 into a format suitable to be transported to the client systems 131, 132. In an embodiment, the response is serialized into a format in accordance with the SOAP message structure. The serialized response is transported to the client systems 131, 132 over the HTTP. The serialized response may be transported to the client systems 131, 132 by Java Messaging Service in an alternative embodiment.

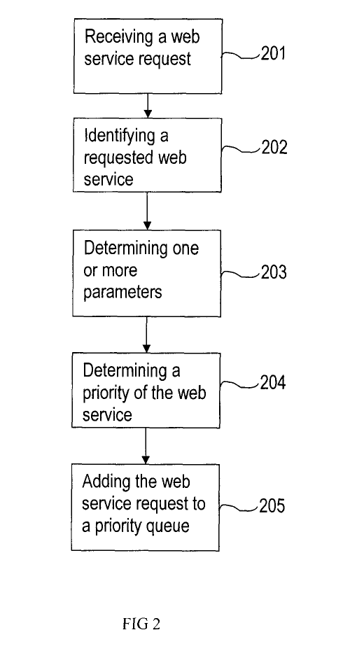

FIG. 2 shows a flow-chart of a process for prioritizing web service requests according to an embodiment. Step 201 includes receiving a web service request. As described earlier, the web service request may be sent by applications residing in client systems. According to an embodiment, the web service request is in accordance with the SOAP message structure. The web service request is received and decoded by the web service container. Specifically, the request is parsed and understood as a web service request for further processing by the web service container.

Step 202 includes identifying a web service being requested (or the End Point Web Service) by the received web service request. The end point web service may be identified from the URL or from the decoded web service request. Step 203 includes determining one or more parameters of the web service request, if any, by deserializing the web service request.

Step 204 includes determining a priority for the web service request. The priority for the web service request is determined based on any business logics. An example of such business logics includes assigning a high priority for emergency events like 911 web service requests and low priority for non-time critical events like movie ticketing. The priority may also be determined based on different classes of customers subscribing to the web services. A web service request from a “Gold” status customer may be assigned a higher priority than a web service request from an “Ordinary” status customer. Additionally, any business logics for handling “Thread Starvation” as described earlier may also be included.

Step 205 includes adding the web service request to a priority queue. The priority queue includes other web service requests which are already arranged according to their respective priorities, with the web service request having the highest priority at the front of the queue, and the web service request having the lowest priority at the end of the queue. The position of the newly added web service request in the priority queue is determined based on its priority with respect to the priorities of the other web service requests. Specifically, the priority of the newly added web service request is compared with the priorities of the other web service requests, and is inserted in the priority queue accordingly. This results in the web service requests in the priority queue to always be arranged according to priority. Therefore, when the web service request at the front of the priority queue is retrieved for processing, the web service request having the highest priority is processed first.

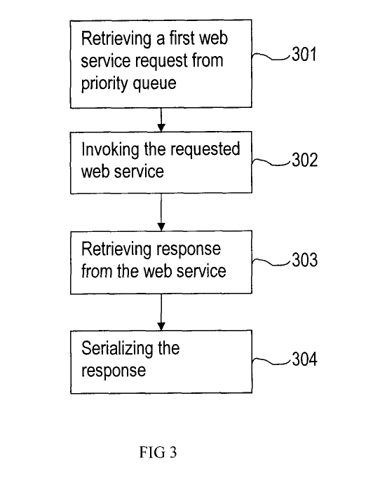

FIG. 3 shows a flow chart of a process for processing web service requests in the priority queue according to an embodiment. Step 301 includes retrieving a web service request from the front of the priority queue. Step 302 includes invoking the web service requested by the retrieved web service request. The web service requested by the retrieved web service request is the end point web service which was identified at Step 202 (see FIG. 2). The end point web service is invoked with the parameters, if any, determined at Step 203 in FIG. 2.

Step 303 includes returning a response from the invoked web service. The response is retrieved and transported to the client systems which requested the web service. In an embodiment, the response is serialized in Step 304 into a SOAP message structure before being transported to the client systems.

The prioritization of requests in a web service container may be implemented using the Java Development Kit (JDK) 1.5 classes in an embodiment. Specifically, the ThreadPoolExecutor, PriorityBlockingQueue and Comparator classes of the JDK 1.5 may be used. An examples of pseudo codes and java code snippets of the implementation of a web service container with web service request prioritization is shown below:

```
WebServiceContainer.java
public class WebServiceContainer
{
//Receive the Web Service Request.
// Find out which Web Service is being requested.
//Deserialize the request parameters
// Calculate the priority of the request based on Business Logic like Priority based on
the Web Service being invoked or based on the Header Parameters.
    priority = //value calculated based on some business logic
//Create a ThreadPoolExecutor with PriorityBlockingQueue.
// The PriorityBlockingQueue takes a Comparator as a parameter.
  ThreadPoolExecutor tpe = new
  ThreadPoolExecutor(1,1,10,TimeUnit.SECONDS, new
  PriorityBlockingQueue(10, new PriorityComparator( )));
//Creating a WebServiceRequestRunnable object passing the priority as a parameter
to the Constructor.
    WebServiceRequestRunnable wsrr = new WebServiceRequestRunnable(
priority);
    tpe.execute(wsrr);
}
WebServiceRequestRunnable.java
import java.util.concurrent.*;
public class WebServiceRequestRunnable implements Runnable
{
    int priority = 0
    public WebServiceRequestRunnable(int p)
    {
        this.priority = p;
    }
    public void run( )
    {
        //Execute the Web Service with the Deserialized Web Service Request
        Parameters.
    }
    public int getPrioirity( )
    {
        return priority;
    }
}
PriorityComparator.java
import java.util.Comparator;
public class PriorityComparator implements Comparator
{
    public int compare( Object o1, Object o2)
    {
        if( ((WebServiceRequestRunnable)o1).getPriority( ) <
        ((WebServiceRequestRunnable)o2).getPriority( ) ) return −1;
        if( ((WebServiceRequestRunnable)o1).getPriority( ) ==
        ((WebServiceRequestRunnable)o2).getPriority( ) ) return 0;
        else return 1;
    }
}
```

In the WebServiceContainer object, a ThreadPoolExecutor object was created with a type of PriorityQueue, namely, PriorityBlockingQueue. The PriorityBlockingQueue uses a PriorityComparator object to compare the priorities of different WebServiceRequestRunnable Objects. After creating the ThreadPoolExecutor object, a priority value for the web service request is calculated. This priority value is passed as a parameter to the constructor of the WebServiceRequestRunnable object.

When the tpe.execute( ) in the WebServiceContainer object is called, the WebServiceRequestRunnable object gets added to the PriorityBlockingQueue. The location of the WebServiceRequestRunnable object in the PriorityQueue is determined by a PriorityComparator object. The PriorityComparator object uses the priority value of the web service request to determine the position of the WebServiceRequestRunnable object in the Queue. The ThreadPoolExecutor executes the WebServiceRequestRunnable object present at the front of the PriorityQueue.

It should be noted that the implementation of the web service container using JDK 1.5 is only an example. Other implementations of the web service container are possible in other embodiments.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for prioritizing web service requests in a web service container, the method comprising:
receiving a web service request;
identifying a web service requested by the web service request;
determining at least one parameter of the web service request, if any;
determining a priority for the web service request; and
adding the web service request to a queue,
wherein the queue includes one or more web service requests, and the positions of the web service requests in the queue are arranged based on their respective priority, and
wherein the web service requests in the queue are processed sequentially, thereby achieving prioritization of web service requests.

2. The method of claim 1, wherein the processing of the web service requests in the queue comprises:
retrieving a web service request from the front of the queue;
invoking a web service requested by the retrieved web service request, wherein when at least one parameter associated with the retrieved web service request is determined, the web service is invoked by the retrieved web service request with the at least one parameter; and
returning a response from the invoked web service corresponding to the retrieved web service request.

3. The method of claim 1, further comprising assigning a thread from a thread pool for processing each of the web service requests in the queue.

4. The method of claim 1, wherein the priority for the web service request is determined based on business logics.

5. The method of claim 2, wherein the web service request is in accordance with the Simple Object Access Protocol (SOAP) and transported to the web service container over the HyperText Transfer Protocol (HTTP).

6. The method of claim 5, further comprising decoding the received web service request to determine information represented within the web service request.

7. The method of claim 6, wherein the web service requested by the web service request is determined from the information obtained from the decoded web service request.

8. The method of claim 5, wherein the determining of the at least one parameter of the web service request comprises deserializing the web service request.

9. The method of claim 5, further comprising serializing the response from the invoked web service into a response message in accordance with the Simple Object Access Protocol (SOAP) which is suitable to be transported to a client requesting the web service.

10. The method of claim 1, further comprising:
comparing the priority of the web service request with the priority of the web service request at the last position in the queue;
switching the position of the web service request with the last web service request if the priority of the web service request is higher than the priority of the last web service request; and
repeatedly comparing the priority of the web service request with the priority of a subsequent web service request in the queue, and switching the position of the web service request with the subsequent web service request if the priority of the web service request is higher than the priority of the subsequent web service request, until the priority of the subsequent web service request is higher than the priority of the web service request.

11. A web service container comprising:
an interceptor for receiving a web service request;
an identifier for identifying a web service requested by the web service request;
a determining unit for determining at least one parameter of the web service request, if any;
a priority calculation unit for determining a priority for the web service request; and
a priority queue for adding the web service request to a queue,
wherein the queue includes one or more web service requests, and the positions of the web service requests in the queue are arranged based on their respective priority, and
wherein the web service requests in the queue are processed sequentially, thereby achieving prioritization of web service requests.

12. The web service container of claim 11, further comprising a processing unit for processing the web service requests in the queue by:
retrieving a web service request from the front of the queue;
invoking a web service requested by the retrieved web service request, wherein when at least one parameter associated with the retrieved web service request is determined, the web service is invoked by the retrieved web service request with the at least one parameter; and
returning a response from the invoked web service corresponding to the retrieved web service request.

13. The web service container of claim 11, wherein the processing unit is a thread pool which assigns a thread for processing each of the web service requests in the queue.

14. The web service container of claim 11, wherein the priority calculation unit determines the priority for the web service request based on business logics.

15. The web service container of claim 12, wherein the web service request is in accordance with the Simple Object Access Protocol (SOAP) and transported to the web service container over the HyperText Transfer Protocol (HTTP).

16. The web service container of claim 15, wherein the interceptor is adapted to decode the received web service request to determine information represented within the web service request.

17. The web service container of claim 16, wherein the web service requested by the web service request is determined from the information obtained from the decoded web service request.

18. The web service container of claim 15, wherein the determining unit comprises a deserializer for deserializing the web service request to determine the at least one parameter of the web service request.

19. The web service container of claim 15, further comprising a serializer for serializing the response from the invoked web service into a response message specified in accordance with the Simple Object Access Protocol (SOAP) which is suitable to be transported to a client requesting the web service.

20. A program storage device readable by a computing device, tangibly embodying a program of instructions, executable by the computing device to perform a method for prioritizing web service requests in a web service container, the method comprising:
receiving a web service request;
identifying a web service requested by the web service request;
determining at least one parameter of the web service request, if any;
determining a priority for the web service request; and
adding the web service request to a queue,
wherein the queue includes one or more web service requests, and the positions of the web service requests in the queue are arranged based on their respective priority, and
wherein the web service requests in the queue are processed sequentially, thereby achieving prioritization of web service requests.
